(19) United States
(12) Patent Application Publication
(10) Pub. No.: US 2002/0120641 A1
(43) Pub. Date: Aug. 29, 2002

(54) Tracking status of inbound trading partner documents

(76) Inventors: Matthew Rozek, Novi, MI (US); Bart Fuller, Grand Blanc, MI (US)

Correspondence Address: William T. Ellis, FOLEY & LARDNER, Washington Harbour, 3000 K Street, N.W., Suite 500, Washington, DC, 20007-5109, US

(21) Appl. No.: 09/748,125

(22) Filed: Dec. 27, 2000

(51) Int. Cl. G06F 17/24

(52) U.S. Cl. 707/500; 707/523

(57) ABSTRACT

Inbound documents received from trading partners are validated (3) for compliance with translation from a source format to a target format. Errors encountered during translation are captured (4) to a tracking database (9). The error data is indexed in the tracking database according to internal document numbers generated (5, 6) according to data extracted from the document and its envelope. The tracking database (9) is then used to provide comprehensive error data for feedback and modification of document-generation systems for improved compatibility.

### BACKGROUND OF THE INVENTION

The invention relates to processing of inbound trading partner documents.

When businesses exchange documents electronically the documents are formatted in a variety of different formats, often none of which are in a format ready to be inputted by the intended destination application. To put these documents into the required application format, a translation process is utilised. Such a translation process is described in U.S. Pat. No. 5,627,972 (RMS Electronic Commerce Systems). As the documents are passed through this translation process, some documents are passed through successfully, while others are interrupted or are passed through conditionally.

The invention is therefore directed towards providing a process to allow for adaptation of both translation processes and sender document preparation to improve the success rate of translation and make it more effective.

### SUMMARY OF THE INVENTION

According to the invention, there is provided a process for tracking inbound documents in a business-to-business electronic commerce system, the process comprising the steps of:

(a) receiving an inbound document at a translator;

(b) the translator checking compliance of the document for translation from a source format to a desired target format;

(c) attempting translation of the document, and capturing error data representing errors to a tracking database; and

(d) extracting data from the document and using it to provide an internal document identifier, and saving the internal document identifier to the tracking database as an index for the error data.

In one embodiment, step (b) comprises attempting recognition of syntax formats within a document data stream for compliance with configured formats, and configuring the translator.

In another embodiment, step (c) comprises parsing the received inbound document field-by-field and, for each field, checking the string byte size and delimiter characters.

In a further embodiment, step (c) further comprises checking sequence of fields against allowable record field groupings including required, optional, or conditional fields.

In a still further embodiment, the translator generates error data in step (c) for field character set, character size, and delimiters and continues translation processing.

In one embodiment, the process is interrupted in step (c) with a return to a document data stream if an error relating to document structure is identified.

In another embodiment, an error is detected at the stage of a mapping process in which a field of a target document is not populated.

In a further embodiment, the translation process is aborted if a target document field is not populated.

In a further embodiment, step (c) comprises identifying errors after construction of a target document and output of said document through a stream.

In one embodiment, step (c) comprises identifying field attribute, truncation, and character set errors after construction of a target document.

In one embodiment, the step (d) comprises extracting data from both a document's enveloping information and from within the document.

In another embodiment, error data is captured by writing values to variables in memory, and subsequently saving said values to the tracking database referenced to the internal document identifiers.

In another embodiment, the memory variables include a temporary variable which can only reference a single value, and in which upon assignment of a subsequent value said subsequent value is treated as a valid variable value.

In one embodiment, the memory variables include a list variable which can reference a plurality of values.

In another embodiment, error data is mapped to said variables according to mapping rules.

In one embodiment, each variable has a label, and referencing a label of a variable in a mapping rule declares said variable.

In another embodiment, the step (c) comprises generating an error code indicating the nature of the error, there being a pre-stored set of error codes and associated descriptions.

According to another aspect, the invention provides a process for tracking inbound documents in a business-to-business electronic commerce system, the process comprising the steps of:

(a) receiving an inbound document at a translator;

(b) the translator checking compliance of the document for translation from a source format to a desired target format;

(c) attempting translation of the document, and capturing error data representing errors to a tracking database; and in which said error data is captured by writing values to variables in memory, said variables comprising:

a temporary variable which can only reference a single value, and in which upon assignment of a subsequent value said subsequent value is treated as a valid variable value, and

a list variable which can reference a plurality of values, in which said error data is mapped according to mapping rules in which a variable label in a rule declares the variable, and in which the error data includes an error code of a pre-stored set of error codes and associated descriptions;

(d) extracting data from the document and using it to provide an internal document identifier, and saving the internal document identifier to the tracking database as an index for the error data.

In another aspect the invention provides an electronic commerce system comprising a translator comprising means for performing a process as described above.

### BRIEF DESCRIPTION OF THE DRAWINGS

The invention will be more clearly understood from the following description of some embodiments thereof, given by way of example only with reference to the accompanying drawings in which:

FIG. 1 is a flow diagram illustrating a tracking process of the invention; and

FIGS. 2 to 14 are sample screen shots illustrating the tracking process and outputs.

### DETAILED DESCRIPTION OF THE INVENTION

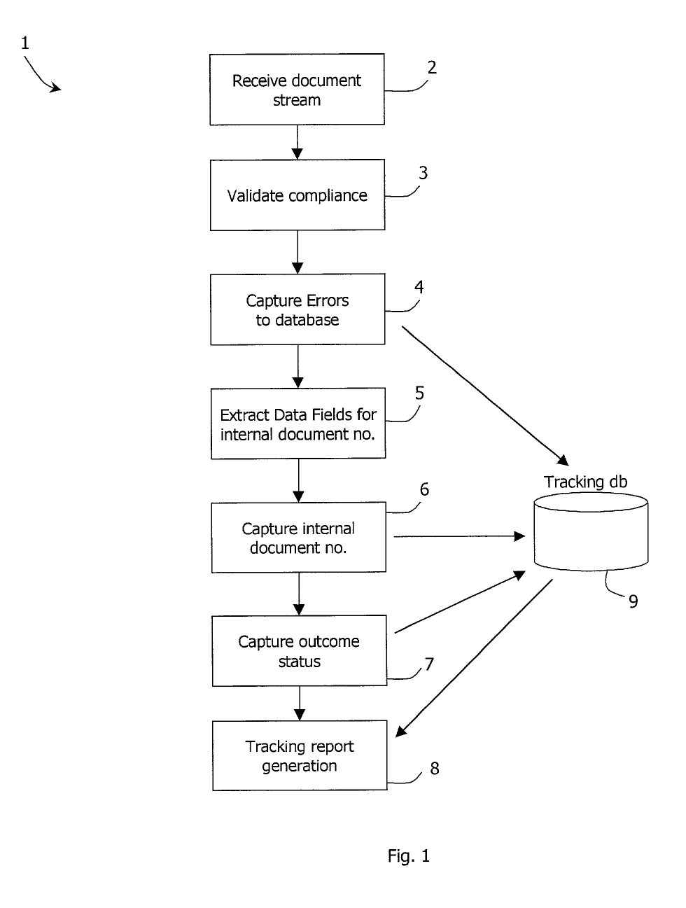

A tracking process 1 is illustrated in FIG. 1. It is implemented in an application integrator business-to-business e-commerce system. This system receives inbound documents from trading partners irrespective of their format, and it sends outbound documents to trading partners.

In the process 1, in step 2 the system receives a stream of data containing documents from a trading partner. Documents are received as a stream from the trading partner, into a translator. Sources of the stream can be: disk files, network sockets, pipes, message queues and Unix FIFO devices. The received input stream can consist of one document or many. They can be in one syntax format or several formats. Some of the various public standard formats supported are: ANSI X12, UN/EDIFACT, TRADACOMS, CII/EIAJ, RosettaNet, XCBL, HIPAA, EANCOM, UCS, VICS, and ODETTE.

In step 3, as each document is processed it is compliance-validated for the format it is to be translated from. In step 4, any errors which are encountered are captured to a tracking database 9. The error data is indexed to internal document numbers generated by extracting data fields in step 5 and capturing a resulting number in step 6. In step 7, the outcome status is determined. These values are saved to the tracking database 9. Later, after the real time processing steps 2-7 during translation, the tracking database 9 is used in a step 8 for providing a report output on the tracking status of each document. This information is used for adapting the translation processes and to provide information to trading partners on how the documents could be improved. Also, the invention allows one to locate the status of an individual document by referencing its internal document number. The report generation step 8 also involves identifying document types which are experiencing particular difficulty.

In more detail, step 3 is required because the syntax formats can be mixed within the same input stream. As a syntax format is recognized, the translator is re-configured to be able to properly parse the data.

For step 4, as the input data is parsed, it is validated by field. For each field, the string is parsed is checked to ensure it exists within that type of fields' character set. The length of the string is compared to defined minimum and maximum sizes. If the field is delimited, the pre and post delimiter(s) are validated for presence in the stream.

Fields are then referenced to other parsed fields to ensure the defined structure of the document is followed—i.e., fields in a specified order, within a record, which can be within a grouping of records. Depending on the fields within the structure, their presence can be required, optional or conditional upon the presence or absence of other fields or records.

As errors are encountered during parsing, some errors are recoverable, while other errors are not. Errors to character set, size, requirement and delimiters can usually be recovered from, so that errors can be captured with processing continuing. This allows for multiple errors on a document to be captured and later reported.

Errors related to the document's structure are often non-recoverable. When the location within the document's structure at which parsing is occurring cannot be identified, parsing must end and a restart within the stream needs to occur. This restart is usually the next document's location. All errors encountered up to and including the structural error are captured for later reporting. Document errors after a non-recoverable error are not recognized or captured.

As the data is being parsed, selective values are assigned to variables, which are labelled memory locations. This is accomplished by a mapping. Mappings consist of rules which define which fields of information are assigned and/or manipulated to variables.

The labelled memory variables are then referenced for their values which are then mapped or assigned to target document fields. The target document is constructed in memory using this mapping process. During this process, errors can be realised from required fields within the document's structure not being populated.

An error encountered and not corrected during the mapping process aborts the construction of the target document.

There are two types of memory variable, namely temporary variables and lists. A temporary variable has a label which begins with “VAR->”. It can only reference a single value. An example is VAR->PartNo. Assigning twice to this variable, only the second assignment would be available upon reference. The second type of memory variable is a list whose label begins with “ARRAY->”. It can be assigned multiple values (a list of values), and can be referenced for the values associated with it. An example of this label is ARRAY->PartNo.

Referencing these labels in the mapping rules declares the memory variable—no preceding step is required to declare or describe the variable. All values on memory variables are strings. Even numeric values and dates are stored as strings in an internal format: sign leading, explicit decimal, when a decimal position is required. A variable can store a value of up to 4,096 characters.

Once the target document has been constructed in memory with no errors, the document is output through a stream. A second level of errors can be encountered during this phase. These errors have to do with field attributes: truncation, or characters being out of character set.

During this process both source parsing errors and target construction and output errors are captured on variables in memory. These variables are then referenced, for their values to be written to the tracking database 9. The error data captured is (a) type of error, and (b) the location or field within the structure. The errors are stored with references back to each document they are associated with.

During translation, the record's sequence number within the message and the fields sequence number within the record are tracked. When an error is encountered, a specific error code (number) is generated by the translator. Examples of the error numbers are:

141 “Mandatory Segment/Record Missing”

146 “Invalid Date, Time or Numeric String”

160 “Error Opening Infile”

161 “Error Opening Outfile”

171 “No Children Found”

176 “Data Field/Element Too Short”

177 “Data Field/Element Too Long”

190 “Mandatory Data Field/Element Missing”

191 “Invalid Character in the Data Field/Element”

192 “Missing Post Delimiter”

193 “Access Model Pre-Condition Not Met”

200 “Unable to Recover”

A general error routine on each object then captures on the list memory variables the specifics about the error. (Comments are after the semi-colon character.)

□
VAR−>OTCodeErr = ERRCODE( ) ; translator error code
VAR−>OTTagSeqNo =
GET_GCOUNT(VAR−>OTTagCnt) + 1 ; record's sequence
number within the message
VAR−>OTCntSeqNo =
GET_ECOUNT(VAR−>OTCompCnt) ; container's sequence
number - groups fields within a record
VAR−>OTDefSeqNo =
GET_ECOUNT(VAR−>OTElemCnt) ; fields sequence
number within the record
VAR−>OTLastTag = LAST_TAG( ) ; record's structure id
VAR−>OTLastDefine = LAST_DEFINING( ) ; field's structure id
□
CLEAR_VAL ARRAY−>OnError_DMIInfo
DMI_INFO(&DMI, &ARRAY−>OnError_DMIInfo)
VAR−>OnError_AccessItemLabel =
GET_ARRAY(&ARRAY−>OnError_DMIInfo,
3); item's reference to access item
VAR−>OnError_DataItemValue =
GET_ARRAY(&ARRAY−>OnError_DMIInfo,
11); value parsed from the input stream
VAR−>OnError_Type =
GET_ARRAY(&ARRAY−>OnError_DMIInfo, 2) ; type of
item in error: record, container, field
VAR−>OnError_FilePos =
GET_ARRAY(&ARRAY−>OnError_DMIInfo, 12) ;
position in the input stream where the error occurred
□; the following lines place the error information on list variables
for later writing out to the database
ARRAY−>OTTagErr =
STRCATM(5, VAR−>OTLastTag, VAR−>OTDelimChar,
VAR−>OTLastMatch,
VAR−>OTDelimChar, NUMTRIM(VAR−>OTTagSeqNo, 0))
ARRAY−>OTDefErr = STRCATM(5, VAR−>OTLastDefine,
VAR−>OTDelimChar,VAR−>OnError_DataItemValue,
VAR−>OTDelimChar,NUMTRIM(VAR−>OTDefSeqNo, 0))
ARRAY−>OTMsgErrText = VAR−>TmpMsg
VAR−>OTErrorCnt =
VAR−>OTErrorCnt + 1; number of errors encountered within
the message ARRAY−>OTCodeErr = VAR−>OTCodeErr

At the end of processing the message, either translating into other format(s) or aborting due to errors, the list variables are referenced for their values and error records are created in the tracking database 9.

In addition to the extracted data being used to map the data to the target document, selected extracted data is also used to generate the internal document identifier. This data is extracted out of both the document's enveloping information and from within the document itself, such as the internal document number (i.e., PO Number, Invoice Number). The internal document identifier is used to reference the error data saved to the tracking database 9.

For step 7, the outcome status of each document being processed is captured in the tracking database 9. This status is controlled by the presence of errors and the configuration of error handling.

If errors are not encountered, the status will be “Translated In”, if the received document stream was from a trading partner. If the document was a re-process of a bypassed document, the status will be “Bypassed Session Reprocessed”.

With errors encountered during either the source parsing or target construction, an error configuration based on the type of error is referenced to determine if the document will be bypassed or rejected. Depending on this reference, the document's status will be either “Translation Error(s), Bypassed” or “Translation Error(s), Rejected”.

One other status a document can have is “Bypassed Session Deleted”. This represents that original processing bypassed the document, and the last process removed or deleted the document from any further processing.

On demand, users can query the document tracking database 9 in step 8. Queries can be specific, by entering selection criteria such as reference numbers or internal document numbers, or general reporting groupings of documents by type, trading partner or other criteria.

Three reports are used for document tracking: Message Activity, Input Viewing, Document Activity and Message Status Update. Each allows for a number of operator selection criteria in generating the report. The reports display: trading partner, document type, status and number of errors, in addition to other information depending on the report.

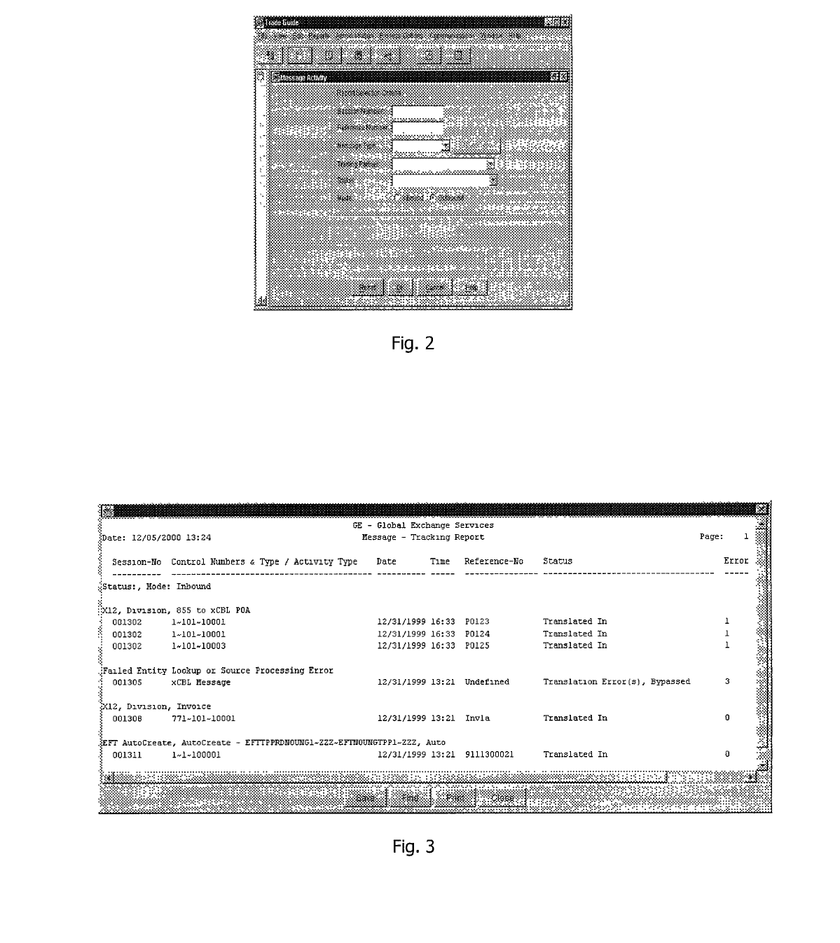

FIG. 2 is an example of a Message Activity report selection window with no selection criteria entered and FIG. 3 is a sample report.

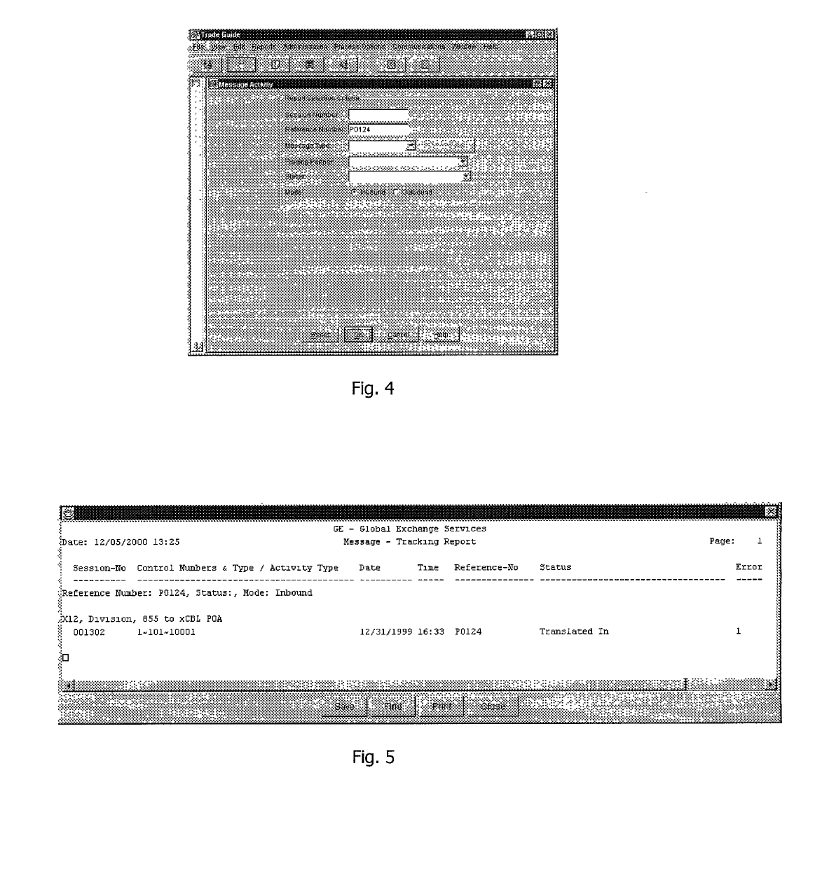

Referring to FIG. 4 a screen is illustrated for specifying a reference number and FIG. 5 illustrates a corresponding tracking report.

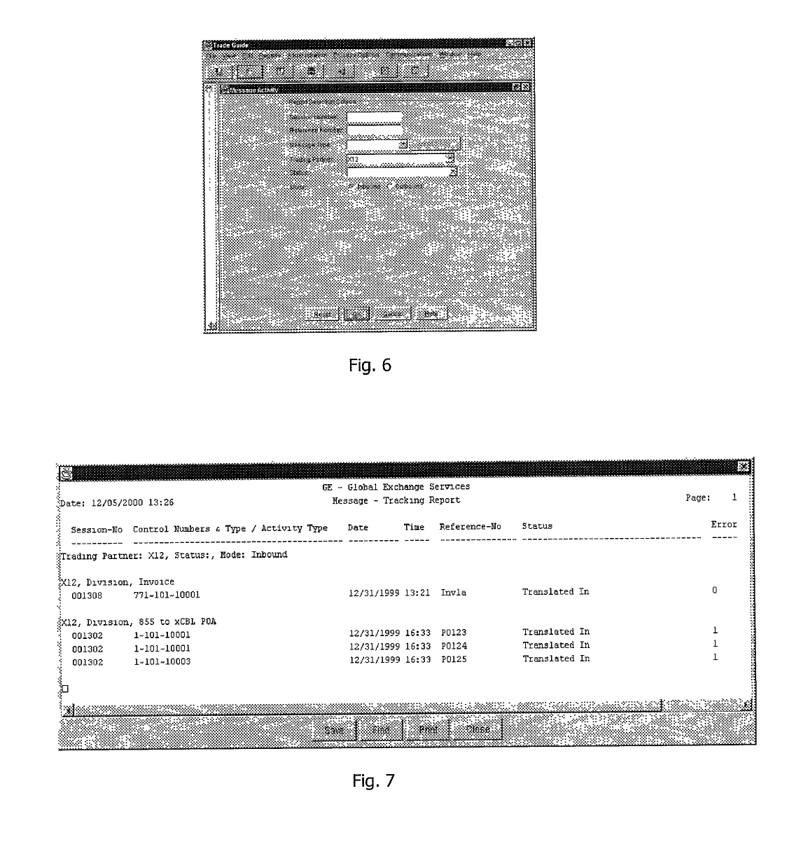

FIG. 6 shows a panel for selecting a trading partner, and a corresponding tracking report is shown in FIG. 7.

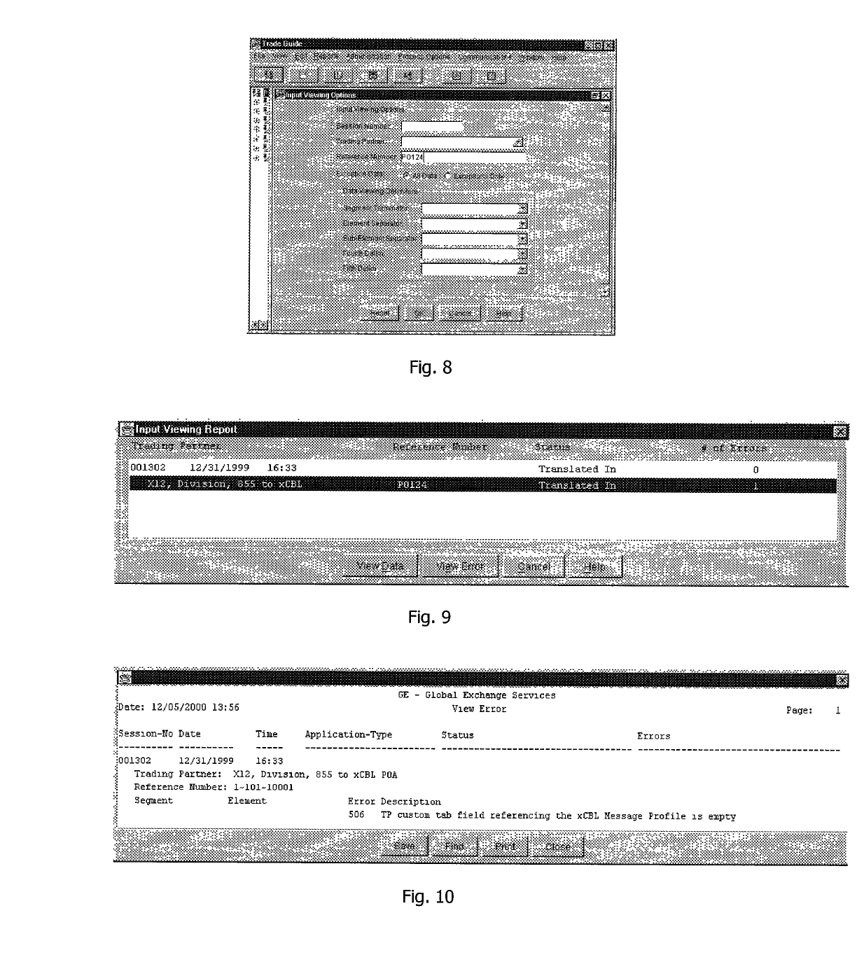

Referring to FIG. 8, there is illustrated a screen for input viewing of inbound documents resulting in a high-level view as shown in FIG. 9. A “View Error” button causes a display such as shown in FIG. 10 to be generated.

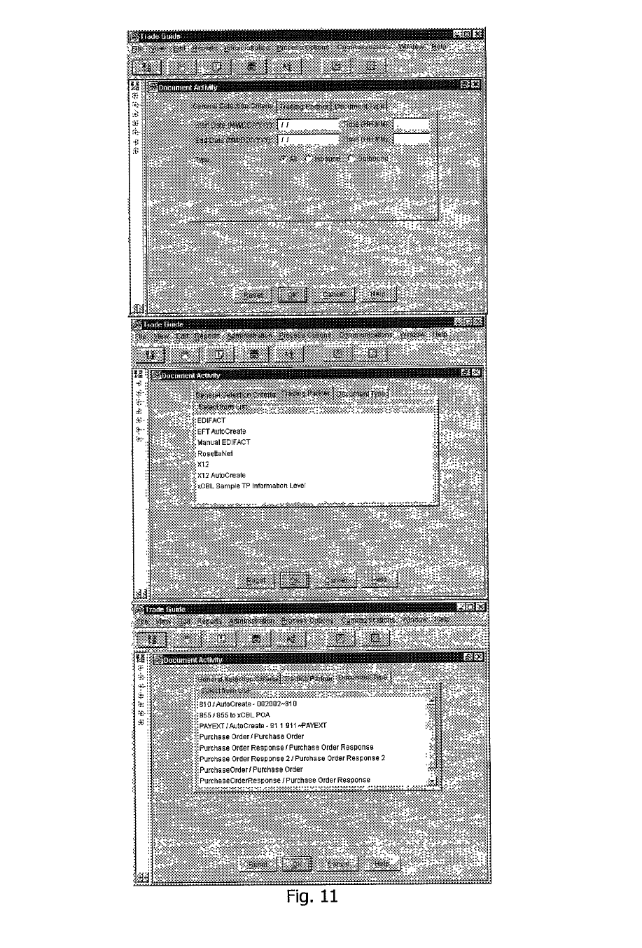

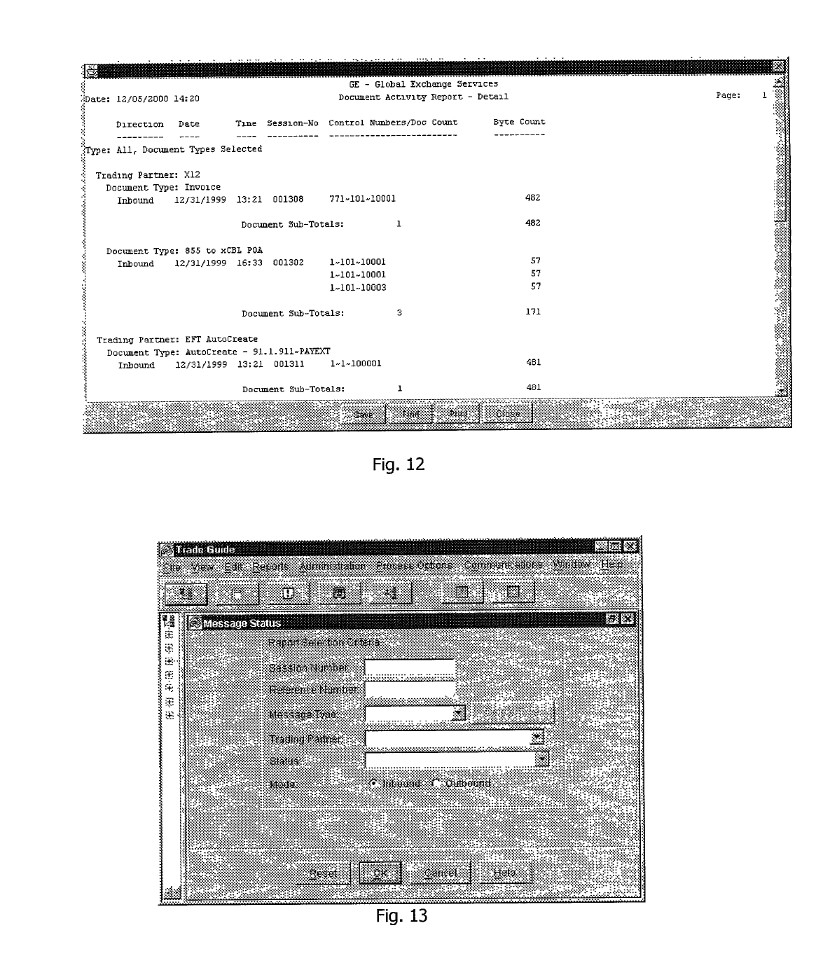

The database 9 may also be used for generating Document Activity reports, such as shown in FIG. 11. A document type is selected, upon which the system generates textual information for instances of the selected document type. Selection of a document from within the list of the third screen of FIG. 11 causes a Document Activity report such as shown in FIG. 12 to be generated. This includes data relating to byte counts and times for documents.

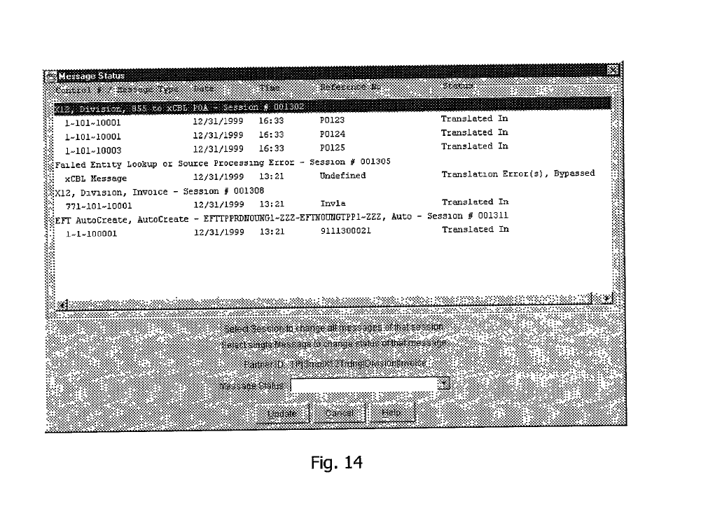

Another function allows for changing a document's status, and a screen as shown in FIG. 13 is displayed. The resulting status report is shown in FIG. 14, with a field for input of a modified status.

It will be appreciated that the invention provides for automatic generation of comprehensive inbound document tracking information. This information is very useful for ongoing adaptation of business-to-business trading partner links. The tracking information includes detailed reasons as to why a document is not passed through to the destination application. The information can be used for correction of the translation process or of the manner in which the document is prepared by the sending trading partner.

The invention is not limited to the embodiments described but may be varied in construction and detail.

What is claimed is:

1. A process for tracking inbound documents in a business-to-business electronic commerce system, the process comprising the steps of:
(a) receiving an inbound document at a translator;
(b) the translator checking compliance of the document for translation from a source format to a desired target format;
(c) attempting translation of the document, and capturing error data representing errors to a tracking database; and
(d) extracting data from the document and using it to provide an internal document identifier, and saving the internal document identifier to the tracking database as an index for the error data.

2. A process as claimed in claim 1, wherein step (b) comprises attempting recognition of syntax formats within a document data stream for compliance with configured formats, and configuring the translator.

3. A process as claimed in claim 1, wherein step (c) comprises parsing the received inbound document field-by-field and, for each field, checking the string byte size and delimiter characters.

4. A process as claimed in claim 3, wherein step (c) further comprises checking sequence of fields against allowable record field groupings including required, optional, or conditional fields.

5. A process as claimed in claim 1, wherein the translator generates error data in step (c) for field character set, character size, and delimiters and continues translation processing.

6. A process as claimed in claim 1, wherein the process is interrupted in step (c) with a return to a document data stream if an error relating to document structure is identified.

7. A process as claimed in claim 1, wherein an error is detected at the stage of a mapping process in which a field of a target document is not populated.

8. A process as claimed in claim 7, wherein the translation process is aborted if a target document field is not populated.

9. A process as claimed in claim 1, wherein step (c) comprises identifying errors after construction of a target document and output of said document through a stream.

10. A process as claimed in claim 9, wherein step (c) comprises identifying field attribute, truncation, and character set errors after construction of a target document.

11. A process as claimed in claim 1, wherein the step (d) comprises extracting data from both a document's enveloping information and from within the document.

12. A process as claimed in claim 1, wherein error data is captured by writing values to variables in memory, and subsequently saving said values to the tracking database referenced to the internal document identifiers.

13. A process as claimed in claim 12, wherein the memory variables include a temporary variable which can only reference a single value, and in which upon assignment of a subsequent value said subsequent value is treated as a valid variable value.

14. A process as claimed in claim 12, wherein the memory variables include a list variable which can reference a plurality of values.

15. A process as claimed in claim 12, wherein error data is mapped to said variables according to mapping rules.

16. A process as claimed in claim 15, wherein each variable has a label, and referencing a label of a variable in a mapping rule declares said variable.

17. A process as claimed in claim 1, wherein the step (c) comprises generating an error code indicating the nature of the error, there being a pre-stored set of error codes and associated descriptions.

18. A process for tracking inbound documents in a business-to-business electronic commerce system, the process comprising the steps of:
(a) receiving an inbound document at a translator;
(b) the translator checking compliance of the document for translation from a source format to a desired target format;
(c) attempting translation of the document, and capturing error data representing errors to a tracking database; and in which said error data is captured by writing values to variables in memory, said variables comprising:
a temporary variable which can only reference a single value, and in which upon assignment of a subsequent value said subsequent value is treated as a valid variable value, and
a list variable which can reference a plurality of values, in which said error data is mapped according to mapping rules in which a variable label in a rule declares the variable, and in which the error data includes an error code of a pre-stored set of error codes and associated descriptions.
(d) extracting data from the document and using it to provide an internal document identifier, and saving the internal document identifier to the tracking database as an index for the error data.

19. An electronic commerce system comprising a translator comprising means for performing a process as claimed in claim 1.

20. A computer program product comprising software code for performing the steps of claim 1 when executing on a digital computer.
